(19) United States
(12) Patent Application Publication
(10) Pub. No.: US 2026/0001333 A1
(43) Pub. Date: Jan. 1, 2026

(54) LIQUID EJECTION DEVICE HAVING WASTE LIQUID TANK REMOVABLE UNDER LIMITED WORK SPACE CONDITIONS

(71) Applicant: BROTHER KOGYO KABUSHIKI KAISHA, Nagoya (JP)

(72) Inventors: Kazushige SAIGUSA, Nagoya (JP); Takeshi YONEYAMA, Kasugai (JP)

(73) Assignee: BROTHER KOGYO KABUSHIKI KAISHA, Nagoya (JP)

(21) Appl. No.: 19/214,223

(22) Filed: May 21, 2025

(30) Foreign Application Priority Data
Jun. 26, 2024 (JP) 2024-103237

(51) Int. Cl. B41J 2/17; B41J 11/00; B41J 29/02; B41J 29/13; B41J 29/393; G01D 5/347

(52) U.S. Cl. CPC B41J 2/1728; B41J 11/0095; B41J 29/02; B41J 29/13; B41J 29/393; G01D 5/34707; G01D 2205/20

(57) ABSTRACT

A liquid ejection device includes a liquid ejection head, a waste liquid tank, a frame, and a cover. The liquid ejection head is configured to eject liquid. The waste liquid tank is configured to store waste liquid ejected from the liquid ejection head. The frame supports the liquid ejection head and the waste liquid tank. The cover is removably attached to the frame and covers the waste liquid tank in a first direction orthogonal to an up-down direction. The waste liquid tank has a first length in the first direction and a second length in a second direction orthogonal to the up-down direction and the first direction. The second length is longer than the first length. The waste liquid tank is removably attached to the frame and is supported to be rotatable, relative to the frame, about a first end portion of the waste liquid tank in the second direction.

### REFERENCE TO RELATED APPLICATIONS

This application claims priority from Japanese Patent Application No. 2024-103237 filed on Jun. 26, 2024. The entire content of the priority application is incorporated herein by reference.

### BACKGROUND ART

An inkjet printer, as an example of a liquid ejection device, has been known that includes a waste ink tank, as an example of a waste liquid tank, a waste ink tank replacement opening formed in a front surface of the printer, and a tank replacement opening cover configured to cover the waste ink tank replacement opening. The waste ink tank of the inkjet printer has a flat rectangular parallelepiped shape that is elongated in a vertical direction and in a front-rear direction of the printer. The waste ink tank is configured to be removably installed in an upright orientation within the printer. For instance, the waste ink tank may be replaced by removing the tank replacement opening cover from the front surface of the printer, and by sliding and pulling the waste ink tank straight forward through the waste ink tank replacement opening.

### SUMMARY

In the known inkjet printer described above, a relatively large space in front of the printer needs to be secured in order to slide out the waste ink tank for replacement. Accordingly, a large working space for attaching or detaching the waste ink tank is required around the inkjet printer.

Aspects of the present disclosure are advantageous in providing one or more improved techniques for a liquid ejection device, which enable attachment and detachment of a waste liquid tank even when a large working space is not available around the liquid ejection device.

According to aspects of the present disclosure, a liquid ejection device is provided, which includes a liquid ejection head, a waste liquid tank, a frame, and a cover. The liquid ejection head is configured to eject liquid. The waste liquid tank is configured to store waste liquid ejected from the liquid ejection head. The frame is configured to support the liquid ejection head and the waste liquid tank. The cover is configured to be removably attached to the frame and cover the waste liquid tank in a first direction orthogonal to an up-down direction. The waste liquid tank has a first length in the first direction and a second length in a second direction orthogonal to the up-down direction and the first direction. The second length is longer than the first length. The waste liquid tank is configured to be removably attached to the frame and to be supported by the frame to be rotatable, relative to the frame, about a first end portion of the waste liquid tank in the second direction.

### BRIEF DESCRIPTION OF DRAWINGS

FIG. 1 is a perspective view of a printer as viewed from a front left side thereof.

FIG. 2 is a schematic plan view showing an internal configuration of the printer.

FIG. 3 is a left side view of the printer.

FIG. 4 is a schematic perspective view of the printer as viewed from a rear left side thereof.

FIG. 5 is an enlarged perspective view showing a partial configuration of the printer from which covers 91 and 93 are removed.

FIG. 6 is a left side view of the printer from which the covers 91 and 93 and an encoder disk are removed.

FIG. 7 is a perspective view of a waste liquid tank.

FIG. 8 is a partial perspective view of the printer, taken along a horizontal plane, showing a configuration around the waste liquid tank attached to the printer from which the cover 93 is removed.

FIG. 9 is a perspective view showing a main portion of a frame.

FIG. 10 is a partial perspective view of the printer, taken along a horizontal plane, showing a configuration around a recessed portion of the cover 93.

FIG. 11 is a cross-sectional plan view of the printer, taken along a horizontal plane, showing a state in which the waste liquid tank and a board are attached to the frame.

FIG. 12 is a cross-sectional plan view of the printer, taken along a horizontal plane, showing a state in which the waste liquid tank is rotated from the frame to which the waste liquid tank and the board are attached.

FIG. 13 is a block diagram showing an electrical configuration of the printer.

### DESCRIPTION

It is noted that various connections are described between elements in the following description. These connections, unless specified otherwise, may be either direct or indirect, and this specification is not intended to be limiting in that respect.

In the present disclosure, an inclusive OR—meaning that it includes either A, B, or both—may be expressed as “A and/or B,” “at least one of A or B,” or “at least one selected from the group consisting of A and B.” Additionally, the expression “one of A or B,” as used herein, refers to a case where A or B is selected exclusively, but not both. The same interpretation applies in cases where three or more selectable elements are considered.

### Illustrative Embodiment

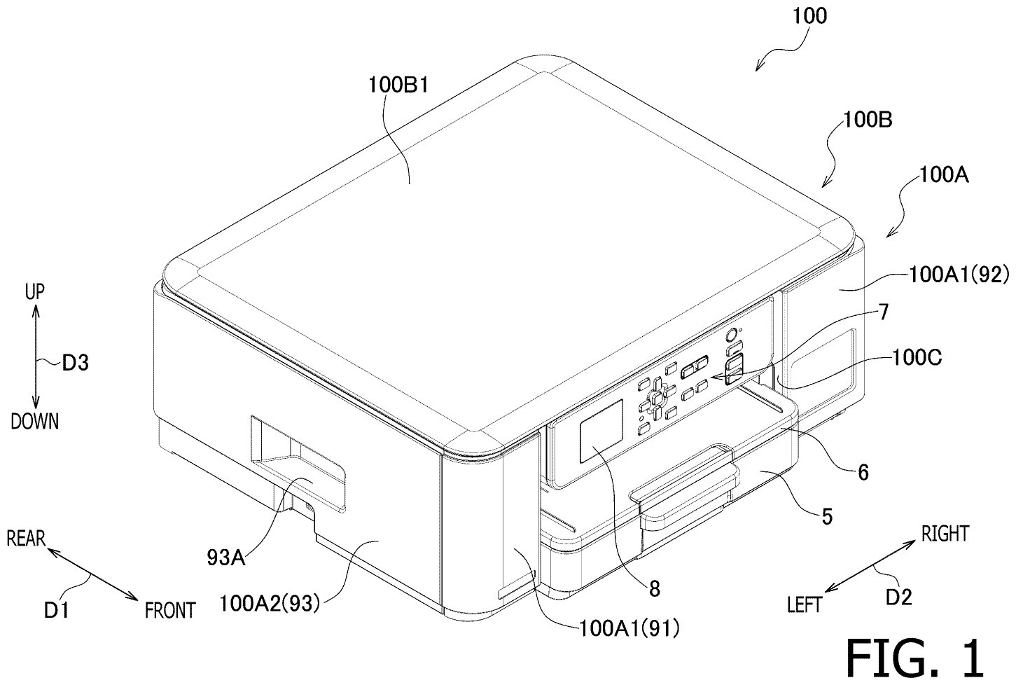

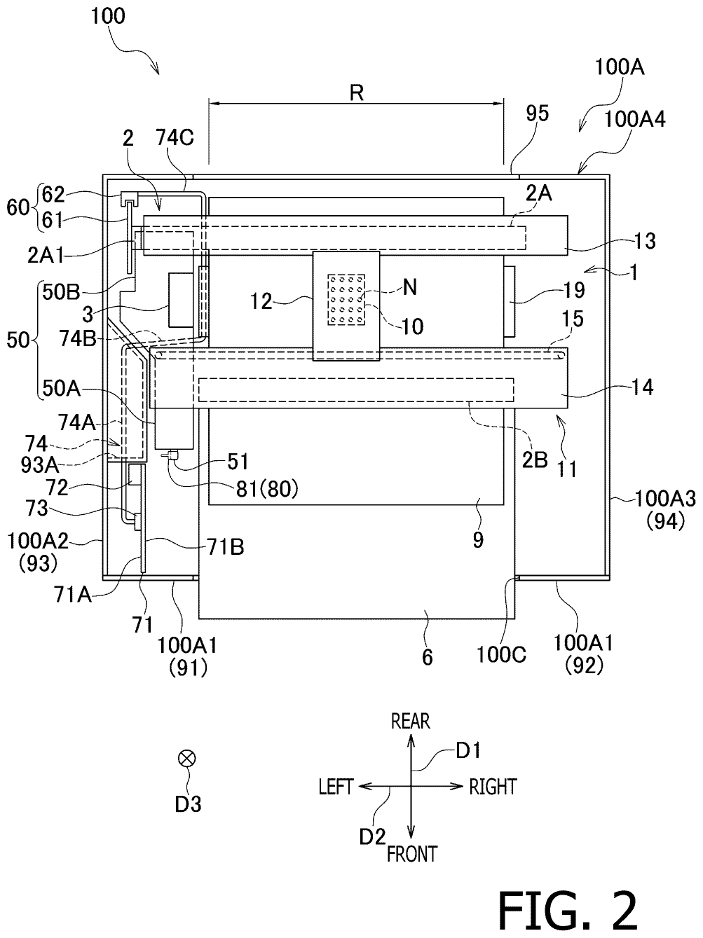

First, with reference to FIGS. 1 and 2, an overall configuration of a printer 100 in an illustrative embodiment according to aspects of the present disclosure is described. The printer 100 in the illustrative embodiment is a so-called multi-function peripheral configured to perform not only printing on a sheet (hereinafter, which may be referred to as a “recording medium”) 9 but also image scanning. In the following description, front-rear directions D1 and left-right directions D2 are horizontal directions and are orthogonal to up-down directions D3. The front-rear directions D1 include a frontward direction and a rearward direction, and are orthogonal to the left-right directions D2. The left-right directions D2 include a leftward direction and a rightward direction, and are defined based on directions when the printer 100 is viewed from the front. The left-right directions D2 may be included as examples of a “first direction” according to aspects of the present disclosure. The front-rear directions D1 may be included as examples of a “second direction” according to aspects of the present disclosure. The up-down directions D3 in the illustrative embodiment include an upward direction and a downward direction that extend in a vertical direction, but may alternatively be directions intersecting with the vertical direction. In such a case, it is sufficient that the front-rear directions D1 and the left-right directions D2 are each orthogonal to the up-down directions D3. Hereinafter, for the sake of explanatory convenience, the front-rear directions D1 and the left-right directions D2 may be referred to in the singular form. Furthermore, the up-down directions D3 may be referred to as the vertical directions D3, and a representative one of the up-down directions D3 may be simply referred to as the vertical direction D3 in the singular form.

### Overall Configuration of Printer

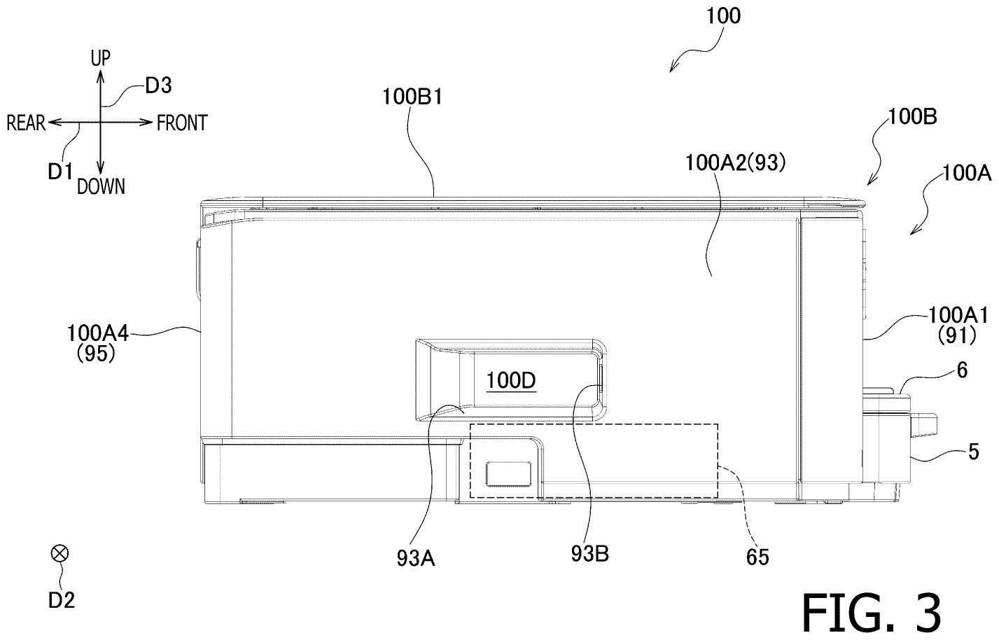

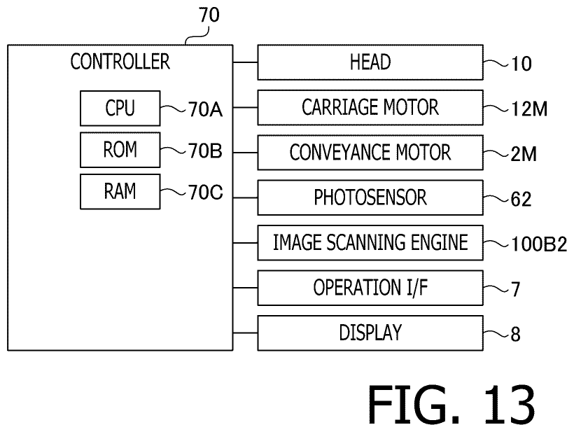

As shown in FIGS. 1 and 2, the printer 100 includes a housing 100A, an image scanner 100B, an image forming engine 1, a conveyor 2, a feed tray 5, a discharge tray 6, an operation I/F (“I/F” is an abbreviation for “interface”) 7, a display 8, a power supply unit 65 (see FIG. 3), and a controller 70 (see FIG. 13). The printer 100 may be an example of a “liquid ejection device” according to aspects of the present disclosure.

The image scanner 100B is disposed to cover an entire upper portion of the housing 100A. The image scanner 100B includes an openable cover 100B1 and an image scanning engine 100B2 (see FIG. 13). The openable cover 100B1 is configured to rotate about a rotation axis positioned at a rear end portion thereof, with a front portion thereof moving in the vertical direction D3 (i.e., an up-down direction D3). The rotation axis of the openable cover 100B1 extends parallel to the left-right direction D2. The image scanning engine 100B2 is disposed between the image forming engine 1 and the openable cover 100B1 in the vertical direction D3. When the openable cover 100B1 is closed, an entire upper surface of the image scanning engine 100B2 is covered by the openable cover 100B1. The image scanning engine 100B2 is configured to output a scanned image to the controller 70.

The housing 100A has a substantially rectangular box shape. The printer 100 further includes, inside the housing 100A, the image forming engine 1, the conveyor 2, a platen 19, a receiver 3, a waste liquid tank 50, an encoder 60, the power supply unit 65, and a board 71 that is included in the controller 70.

As shown in FIG. 1, the housing 100A has an opening 100C formed substantially at a center of a front wall 100A1 of the housing 100A. In the opening 100C, the feed tray 5 and the discharge tray 6 are disposed in a vertically stacked manner. In the illustrative embodiment, the discharge tray 6 is placed on top of the paper feed tray 5. The feed tray 5 and the discharge tray 6 are insertable and removable along the front-rear directions D1 through the opening 100C. Namely, the feed tray 5 and the discharge tray 6 are configured to be detachably attached to the housing 100A.

As shown in FIGS. 1 and 3 to 6, the housing 100A includes five covers 91 to 95 and a frame 80. The frame 80 is configured to support the image forming engine 1, the conveyor 2, the waste liquid tank 50, and the board 71.

Among the five covers 91 to 95, the covers 91 and 92 form the front wall 100A1. The cover 93 forms a left side wall 100A2 and a left end portion of a rear wall 100A4. The cover 94 forms a right side wall 100A3 and a right end portion of the rear wall 100A4. The cover 95 forms a middle portion of the rear wall 100A4 in the left-right direction D2. Each of the five covers 91 to 95 is supported on the frame 80 by screws and engaging claws in a manner that allows each cover to be attached to and detached from the frame 80. The covers 91 to 95 may be easily removed from the frame 80 by disengaging the screws and the engaging claws, and may likewise be easily attached by reversing the removal procedure.

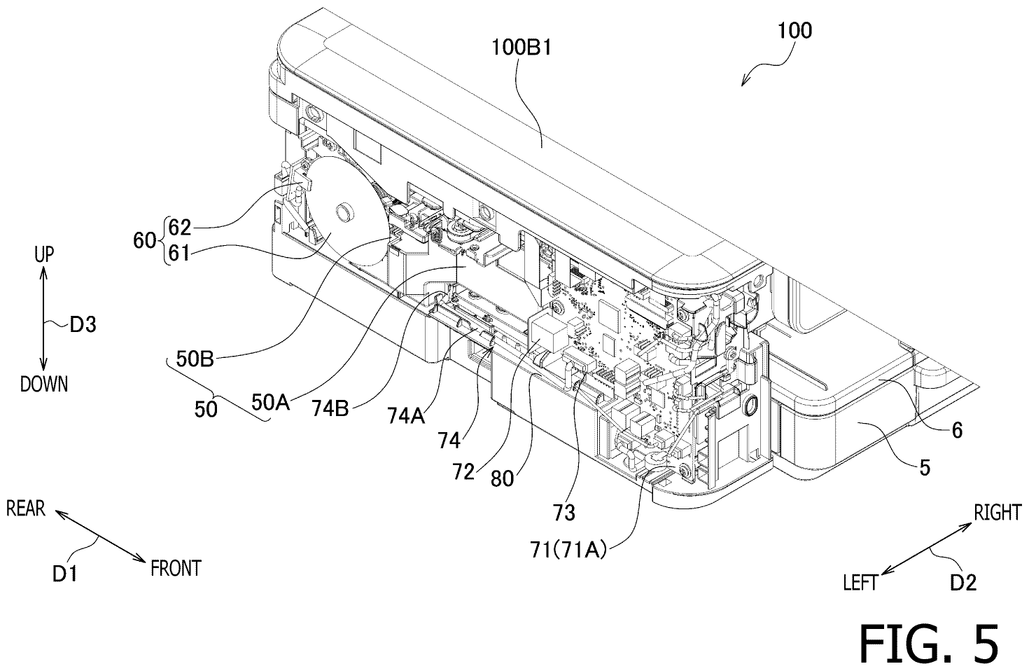

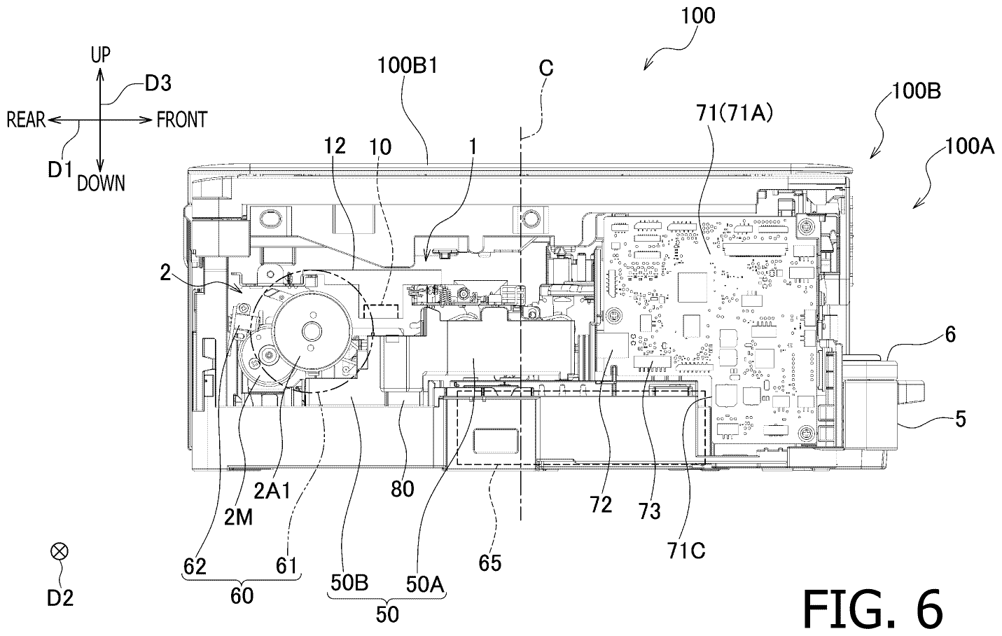

As shown in FIGS. 1 and 5, the cover 91, which forms a left portion of the front wall 100A1, is attached to the frame 80 in a manner that allows the cover 91 to cover a front end of the board 71 in the front-rear direction D1. It is noted that the expression “A covers B in a specific direction” refers to a case where “B is covered by A as viewed in the specific direction.” The cover 91 and the cover 93 are separable from each other. As shown in FIG. 2, the cover 91 is configured to cover the waste liquid tank 50 in the front-rear direction D1. As shown in FIGS. 3 and 6, the cover 93 is attached to the frame 80 in a manner that allows the cover 93 to cover, in the left-right direction D2, the image forming engine 1, the conveyor 2, the receiver 3, the waste liquid tank 50, the encoder 60, the power supply unit 65, and a major portion of the board 71. In addition, the cover 93 includes a recessed portion 93A, recessed toward the waste liquid tank 50 side, at a portion thereof that faces, in the left-right direction D2, a region extending from a middle portion to a front end portion of the waste liquid tank 50 in the front-rear direction D1.

As shown in FIGS. 2 and 6, the image forming engine 1 includes a head 10 and a head movement mechanism 11. The head movement mechanism 11 includes a carriage 12, two guides 13 and 14, a belt 15, and a carriage motor 12M (see FIG. 13). The carriage 12 is configured to hold the head 10 mounted thereon. The two guides 13 and 14 are configured to support the carriage 12. The belt 15 is connected to the carriage 12. The guides 13 and 14 and the belt 15 extend in a scanning direction parallel to the left-right direction D2. When the carriage motor 12M is driven under control of the controller 70, the belt 15 moves, and the carriage 12 moves in the scanning direction along the guides 13 and 14.

The head 10 is supplied with ink from ink tanks (not shown). As shown in FIG. 2, the head 10 has a plurality of nozzles N formed in a lower surface thereof. The plurality of nozzles N are arranged in four nozzle rows along the scanning direction. Each nozzle row is formed by arranging multiple nozzles N in the front-rear direction D1. The plurality of nozzles N are configured to eject black, yellow, cyan, and magenta inks from the four nozzle rows, respectively, in this order from the rightmost nozzle row in the scanning direction.

The platen 19 is a plate extending along a plane orthogonal to the vertical direction D3. The platen 19 is disposed below the head 10. The platen 19 is configured to support a sheet 9, which is conveyed by the conveyor 2, from beneath on an upper surface of the platen 19.

The conveyor 2 includes two rollers 2A and two rollers 2B. The two rollers 2A are opposed to the two rollers 2B across the platen 19 in the front-rear direction D1. When a conveyance motor 2M (see FIGS. 6 and 13) is driven under control of the controller 70, the rollers 2A and the rollers 2B rotate while holding the sheet 9, thereby conveying the sheet 9 in a conveying direction along the front-rear direction D1 from rear to front. A sheet 9 stored in the feed tray 5 is fed to the conveyor 2 by a sheet feeder (not shown). The sheet 9 conveyed by the conveyor 2 is discharged onto the discharge tray 6.

As shown in FIGS. 2 and 5, the encoder 60 is a known encoder including an encoder disk 61 and a photosensor 62. The encoder 60 is used to detect a conveyance amount of the sheet 9 conveyed by the two rollers 2A. As shown in FIGS. 2 and 6, a disk attachment portion 2A1 is disposed at a left end portion of a specific one of the two rollers 2A. The disk attachment portion 2A1 is configured to rotate coaxially with the specific roller 2A. The encoder disk 61 is removably attached to the disk attachment portion 2A1. The encoder disk 61 has a circular shape slightly larger than the disk attachment portion 2A1, and is affixed to the disk attachment portion 2A1 with double-sided tape. A plurality of slits (not shown) are formed along a circumferential direction at an outer peripheral edge of the encoder disk 61. The encoder disk 61 is disposed between the waste liquid tank 50 and the cover 93 in the left-right direction D2, and is positioned to partially overlap a rear portion 50B of the waste liquid tank 50 in the left-right direction D2.

As shown in FIGS. 2 and 5, the photosensor 62 is disposed to sandwich an outer peripheral edge of the encoder disk 61 in the left-right direction D2. More specifically, the photosensor 62 includes a light-emitting element and a light-receiving element. The light-emitting element and the light-receiving element are opposed to each other across the outer peripheral edge of the encoder disk 61 in the left-right direction D2. The photosensor 62 is configured to detect the presence or absence of slits formed in the encoder disk 61, and to output a detection signal to the controller 70. Based on the detection signal from the photosensor 62, the controller 70 calculates and detects a conveyance amount of the sheet 9 conveyed by the two rollers 2A.

As shown in FIG. 2, the receiver 3 is configured to receive, as waste liquid, ink ejected from the nozzles N during flushing. The receiver 3 is disposed between the guides 13 and 14 in the front-rear direction D1. The receiver 3 is also disposed to the left of a conveyance region R in the left-right direction D2, that is, closer to the cover 93 than the conveyance region R is. The conveyance region R is a region in which the sheet 9 is conveyed by the conveyor 2.

The receiver 3 is formed of a plate-shaped member. The receiver 3 has a length in the front-rear direction D1 that is longer than a length of the nozzle rows in the front-rear direction D1. The receiver 3 is disposed above the waste liquid tank 50 and is positioned to overlap the waste liquid tank 50 in the vertical direction D3. It is noted that the expression “A overlaps B in a specific direction” refers to a case where “A and B overlap each other as viewed in the specific direction.” The receiver 3 is inclined, with a right end portion positioned higher than a left end portion. Thus, the receiver 3 is configured to guide ink (i.e., waste liquid) received during flushing to flow into the waste liquid tank 50, thereby causing ink ejected from the head 10 during flushing to be discharged into the waste liquid tank 50.

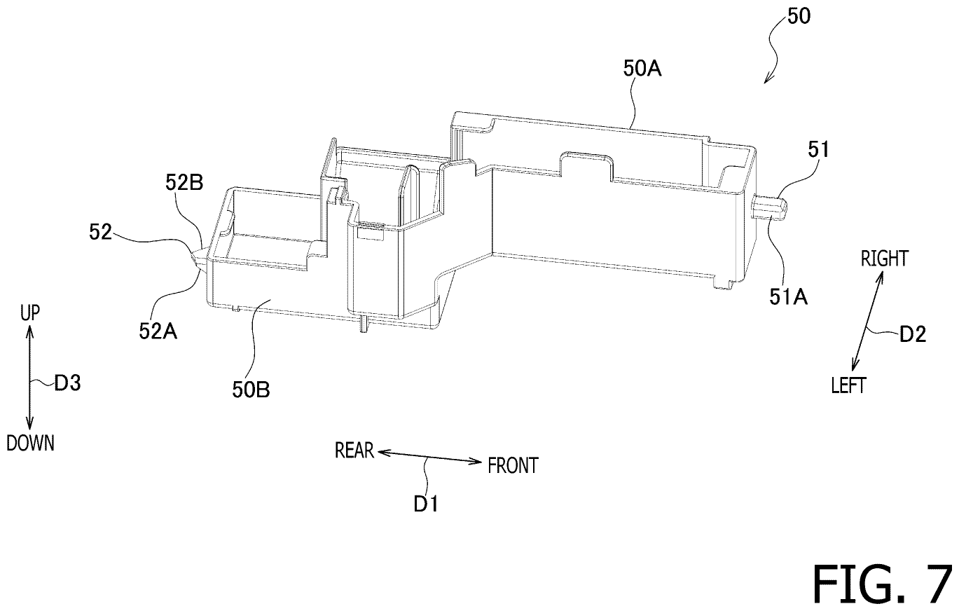

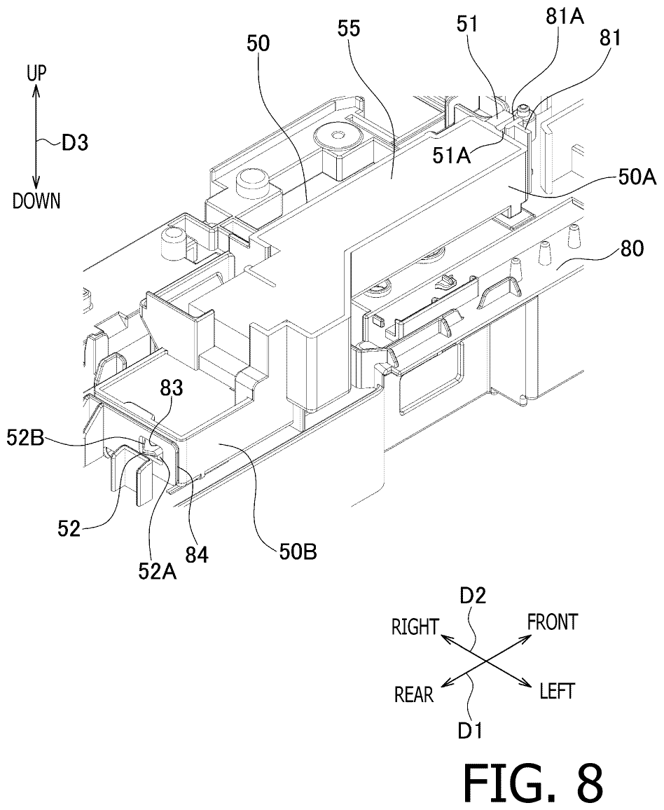

As shown in FIGS. 2 and 7, the waste liquid tank 50 extends in the front-rear direction D1 and has a length in the front-rear direction D1 that is longer than a length thereof in the left-right direction D2. The waste liquid tank 50 has a box shape open at the top, and includes an ink absorber 55 (see FIG. 8) disposed therein. In the illustrative embodiment, a urethane foam configured to absorb liquid is used as the ink absorber 55. However, any type of absorber may be used, provided that it is configured to absorb liquid. The ink absorber 55 may not necessarily be disposed in the waste liquid tank 50.

The waste liquid tank 50 includes a protrusion 51 at a front end thereof and a projection 52 at a rear end thereof. The protrusion 51 protrudes forward from the front end of the waste liquid tank 50. The protrusion 51 includes a prismatic portion having chamfered corners. As shown in FIGS. 7 and 8, the protrusion 51 has an abutment surface 51A configured to contact a boss portion 81 (to be described later) of the frame 80. The abutment surface 51A is a flat surface extending in the vertical direction D3 and the front-rear direction D1, and constitutes a left side surface of the protrusion 51.

The projection 52 protrudes rearward from the rear end of the waste liquid tank 50. Both end surfaces 52A and 52B of the projection 52 in the left-right direction D2 are inclined in a manner that causes the projection 52 to taper toward the rear.

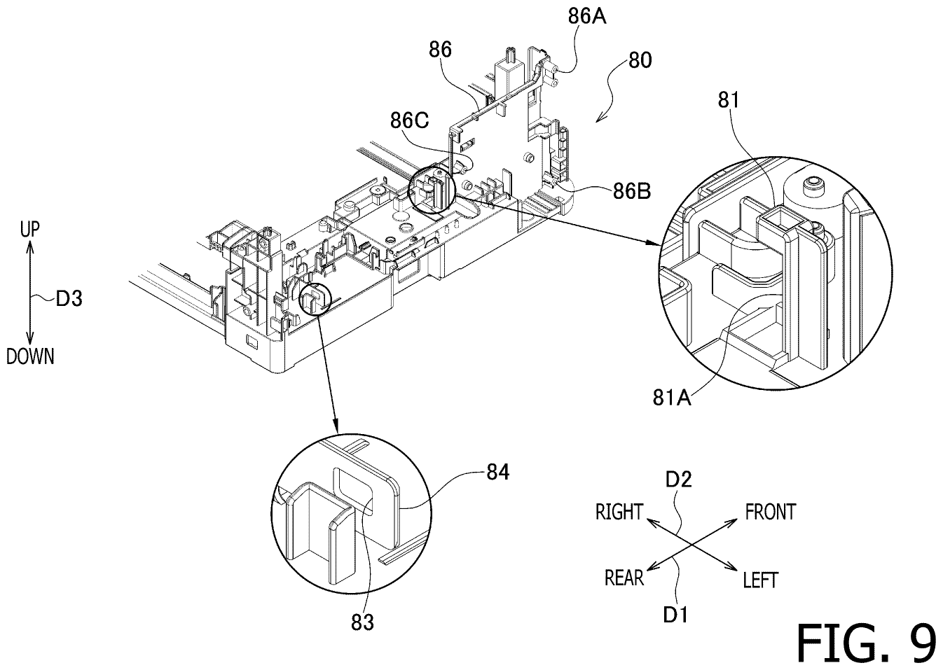

As shown in FIG. 9, the frame 80 includes a boss portion 81, a plate member 84 having a hole 83, and a board support portion 86. The boss portion 81 extends in the vertical direction D3 and has a recessed shape opened toward the right. The boss portion 81 includes a boss surface 81A formed as a bottom surface of the recessed shape. The boss surface 81A is a flat surface extending in the vertical direction D3 and the front-rear direction D1. The boss surface 81A is configured to contact the abutment surface 51A of the waste liquid tank 50 when the waste liquid tank 50 is attached to or detached from the frame 80, thereby serving as a rotation fulcrum. The boss surface 81A is opposed to and parallel to the abutment surface 51A of the waste liquid tank 50 when the waste liquid tank 50 is attached to the frame 80. The boss surface 81A is further configured to restrict leftward movement of the waste liquid tank 50 when the boss surface 81A is in contact with the abutment surface 51A.

The plate member 84 is disposed along the left-right direction D2 and is configured in a cantilevered shape, with a right end fixed and a left end serving as a free end. That is, the plate member 84 is bendable in such a manner that the left end is displaceable in the front-rear direction D1. In the illustrative embodiment, the hole 83 extends through the plate member 84 in the front-rear direction D1 and is configured to allow insertion of the projection 52. In another instance, the hole 83 may be formed as a recess that does not extend through the plate member 84 in the front-rear direction D1, provided that it allows insertion of the projection 52. When the projection 52 of the waste liquid tank 50 is inserted into and locked within the hole 83 of the plate member 84, the waste liquid tank 50 is supported by the frame 80.

The board support portion 86 is disposed in front of the boss portion 81. The board support portion 86 is formed of a plate-shaped member extending in the front-rear direction D1 and the vertical direction D3. The board support portion 86 includes three screw holes 86A to 86C for fixing the board 71. Among the three screw holes 86A to 86C, the two screw holes 86A and 86B are positioned at a front part of the board support portion 86, and the screw hole 86C is positioned at a rear part thereof. The three screw holes 86A to 86C are disposed at different positions in the vertical direction D3.

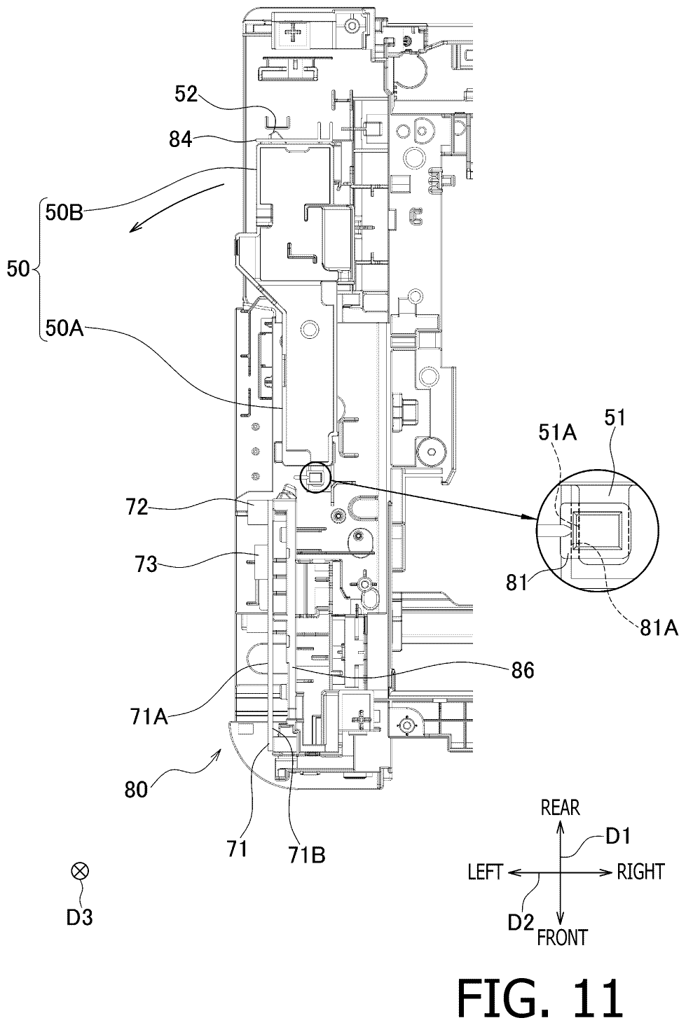

As shown in FIG. 7, the waste liquid tank 50 includes a front portion 50A including a front end portion, and a rear portion 50B including a rear end portion, which are arranged in the front-rear direction D1. The front portion 50A is disposed above the rear portion 50B. As shown in FIGS. 2 and 11, the rear portion 50B is longer than the front portion 50A in the left-right direction D2. In addition, the rear portion 50B is disposed to overlap a connector 72 (to be described later) of the board 71 in the front-rear direction D1. Furthermore, the front portion 50A is disposed not to overlap the connector 72 in the front-rear direction D1. The recessed portion 93A of the cover 93 is disposed to the left of the front portion 50A, and is positioned between the connector 72 and the rear portion 50B.

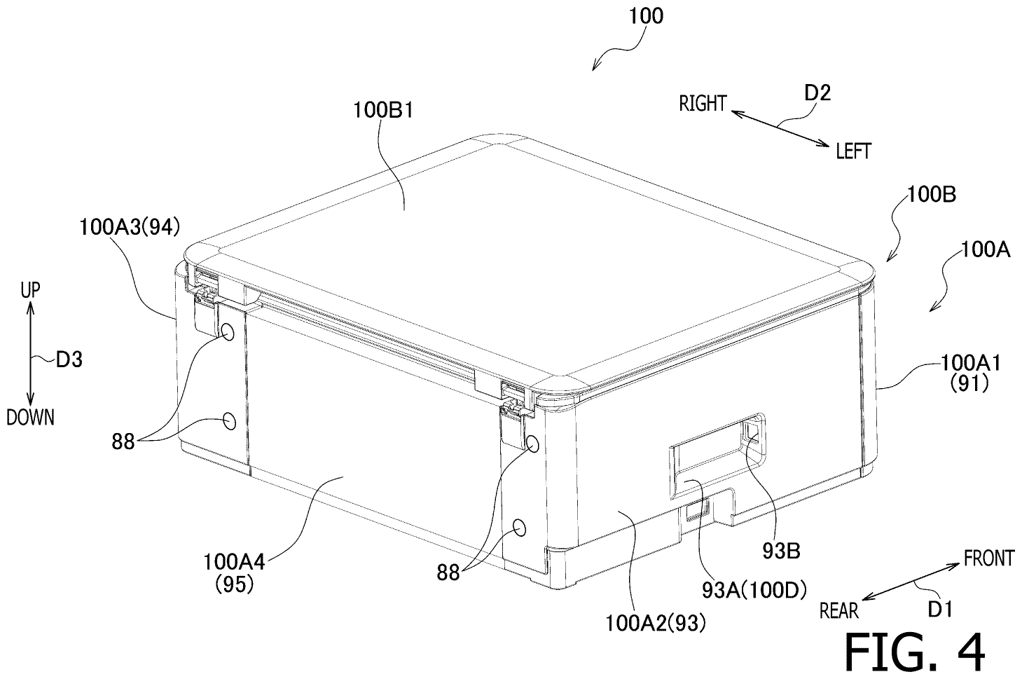

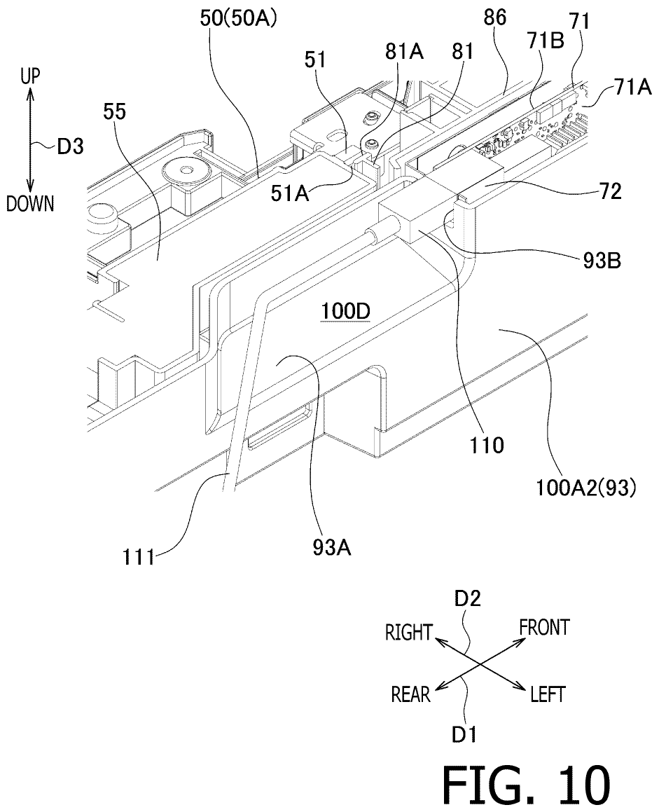

As shown in FIGS. 4 and 10, a through-hole 93B is formed in a front side surface of the recessed portion 93A. The through-hole 93B is positioned to face the connector 72 in the front-rear direction D1. A wiring arrangement space 100D is provided in a region surrounded by the recessed portion 93A of the cover 93. The wiring arrangement space 100D is configured to partially accommodate a wiring 111 that is connected to an external connector 110 mated with the connector 72. The wiring arrangement space 100D is disposed to the left of the waste liquid tank 50 and at a position displaced rearward from the connector 72.

As shown in FIG. 11, the board 71 is disposed to the left of the board support portion 86 and in front of the waste liquid tank 50. That is, the board 71 is disposed in front of the waste liquid tank 50 and is positioned not to overlap the waste liquid tank 50 in the left-right direction D2. As shown in FIGS. 5 and 6, the board 71 is formed of a plate-shaped member extending in the front-rear direction D1 and the vertical direction D3.

Electronic components such as connectors 72 and 73 are mounted on both a left surface 71A and a right surface 71B of the board 71. As shown in FIGS. 5 and 6, the connectors 72 and 73 are mounted on the left surface 71A of the board 71, although electronic components mounted on the right surface 71B are not illustrated. As shown in FIG. 6, the board 71 includes a cutout portion 71C from which a portion overlapping the power supply unit 65 in the left-right direction D2 is removed. Accordingly, the cutout portion 71C is configured not to overlap the power supply unit 65 in the left-right direction D2.

The connector 72 in the illustrative embodiment is a board-mounted female USB connector. The connector 72 is configured to mate with the external connector 110. The external connector 110 in the illustrative embodiment is a male USB connector. The connector 72 is mounted on the board 71 in such a manner that an insertion direction (frontward) and a removal direction (rearward) of the external connector 110 with respect to the connector 72 are aligned parallel to the front-rear direction D1.

The connector 73 in the illustrative embodiment is a female connector for a coaxial harness. A coaxial harness 74 is connected to the connector 73. As shown in FIG. 2, the coaxial harness 74 has one end (i.e., a front end) connected to the connector 73 and the other end (i.e., a rear end) connected to the photosensor 62. As shown in FIGS. 2 and 5, the coaxial harness 74 includes a first portion 74A disposed in front of a rear end of the front portion 50A of the waste liquid tank 50. The first portion 74A is disposed below the waste liquid tank 50 and to the left of the front portion 50A. The coaxial harness 74 further includes a middle portion 74B connected at one end (i.e., a left end) to a rear end of the first portion 74A. The middle portion 74B is disposed below the waste liquid tank 50 and extends across the waste liquid tank 50 from left to right. The coaxial harness 74 further includes a second portion 74C connected to the other end (i.e., a right end) of the middle portion 74B. The second portion 74C extends rearward and is connected to the photosensor 62.

The power supply unit 65 is configured to supply electric power to electronic components (including the connectors 72 and 73) mounted on the board 71, the photosensor 62, the carriage motor 12M, the conveyance motor 2M, and the head 10. As shown in FIG. 6, the power supply unit 65 extends in the front-rear direction D1 and is disposed below the waste liquid tank 50. A front end of the power supply unit 65 is positioned in front of a center line C that passes through a center of the housing 100A in the front-rear direction D1, and a rear end thereof is positioned behind (i.e., to the rear of) the center line C. That is, a part of the power supply unit 65 is positioned in front of the center of the housing 100A in the front-rear direction D1.

As shown in FIG. 13, the controller 70 includes a CPU 70A, a ROM 70B, and a RAM 70C. The controller 70 is configured to control operations of the head 10, the carriage motor 12M, the conveyance motor 2M, the photosensor 62, the image scanning engine 100B2, and the display 8. The CPU 70A is configured to perform various control processes based on data input from an external device or the operation I/F 7, in accordance with programs and data stored in the ROM 70B and the RAM 70C. The external device may be, for instance, a personal computer (PC). The controller 70 is further configured to calculate and detect the conveyance amount of the sheet 9 based on a detection signal from the photosensor 62.

The ROM 70B is configured to store programs and data used by the CPU 70A to execute various control processes. The RAM 70C is configured to temporarily store data used by the CPU 70A during execution of the programs.

Next, a procedure for attaching and removing the waste liquid tank 50 is described below with reference to FIGS. 1, 4 to 6, 11, and 12.

To remove the waste liquid tank 50 from the printer 100, the cover 91 shown in FIG. 1 is first removed from the frame 80, followed by removal of the cover 93 from the frame 80. The cover 91 is configured to cover a front end portion of the cover 93 from the outside. Therefore, the cover 91 needs to be removed before removing the cover 93. When the openable cover 100B1 is opened, screws (not shown) that fix the cover 91 to the frame 80 are exposed. After removing these screws, the cover 91 is removed from the frame 80 by disengaging engaging claws (not shown) of the cover 91 from the frame 80.

Next, two screws 88 (see FIG. 4) that fix the cover 93 to the frame 80 are removed. Then, by disengaging engaging claws (not shown) of the cover 93 from the frame 80, the cover 93 is removed from the frame 80, as shown in FIG. 5. Thereafter, the encoder disk 61, attached to the disk attachment portion 2A1 with double-sided tape, is peeled off and removed from the disk attachment portion 2A1, as shown in FIG. 6. As a result, no elements of the printer 100 that would interfere with the waste liquid tank 50 remain to the left of the waste liquid tank 50.

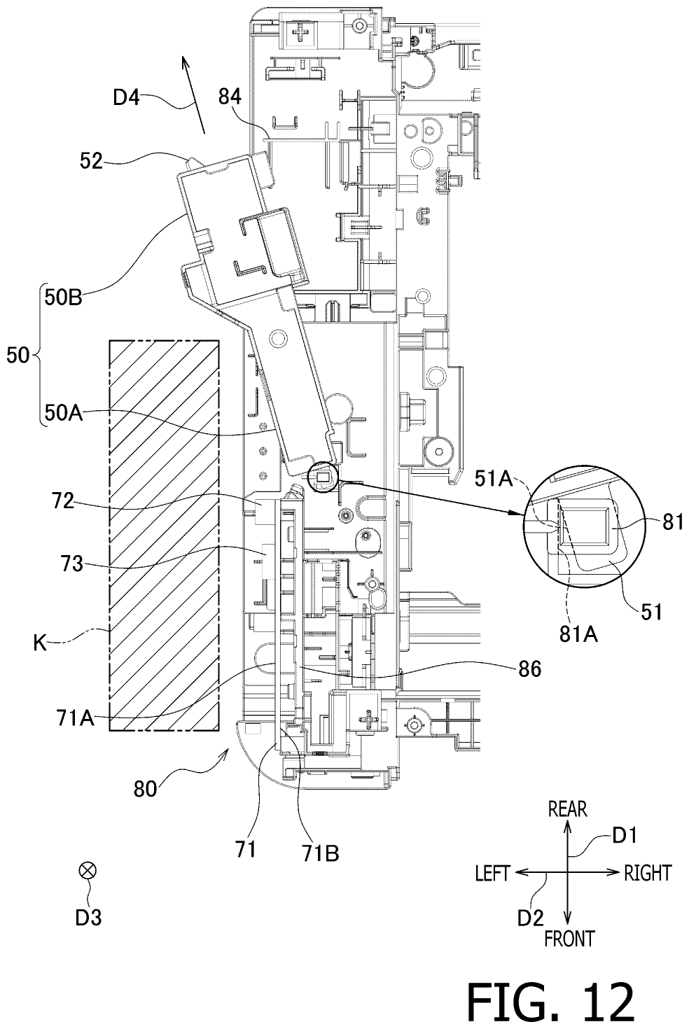

Next, the left end of the plate member 84 is displaced rearward, thereby disengaging the projection 52 of the waste liquid tank 50 from the hole 83. That is, the engagement of the waste liquid tank 50 by the plate member 84 is released. Then, as shown in FIG. 11, the rear portion 50B of the waste liquid tank 50 is rotated leftward. More specifically, as shown in FIG. 12, the rear portion 50B is rotated leftward about a rotation center positioned at a front end portion of the waste liquid tank 50 where the abutment surface 51A of the waste liquid tank 50 is in contact with the boss surface 81A of the frame 80. The amount of this leftward rotation is sufficient to allow the waste liquid tank 50, when moved in a removal direction D4 parallel to the longitudinal direction of the waste liquid tank 50, not to interfere with any elements of the printer 100, such as the frame 80. The removal direction D4 is a direction from the front end toward the rear end of the waste liquid tank 50.

Subsequently, the waste liquid tank 50 is moved in the removal direction D4, whereby the waste liquid tank 50 is removed from the frame 80. Thus, the waste liquid tank 50 is enabled to be removed from the frame 80. Therefore, even if an obstacle K, shown enclosed by a chain double-dashed line in FIG. 12, is located to the left of the printer 100 and to the left of the front portion 50A of the waste liquid tank 50, the waste liquid tank 50 is still removable from the frame 80. That is, the waste liquid tank 50 is attachable to or removable from the frame 80, provided that there is a work space located to the left of the cover 93 of the printer 100 and to the rear of the center of the printer 100 in the front-rear direction D1. It is noted that the attachment of the waste liquid tank 50 to the printer 100 may be performed in the reverse order of the aforementioned removal procedure. Thus, the procedure of removing the waste liquid tank 50 from the printer 100 and attaching another one to the printer 100 is completed, enabling easy replacement of the waste liquid tank 50.

As described above, according to the printer 100 in the illustrative embodiment, after the cover 93 is removed, the waste liquid tank 50 is rotated with a front end portion thereof serving as a rotation center. The waste liquid tank 50 is then moved in the removal direction D4, whereby the waste liquid tank 50 is removed from the frame 80. The attachment of the waste liquid tank 50 to the frame 80 may be performed in the reverse order of the aforementioned removal procedure. Accordingly, even if a large work space is not available to the left of a portion of the cover 93 that covers the waste liquid tank 50, the waste liquid tank 50 is still attachable to and removable from the frame 80. Furthermore, even when an obstacle K is located to overlap the front portion 50A of the waste liquid tank 50 in the left-right direction D2, the waste liquid tank 50 is enabled to be attached to and removed from the frame 80 without interfering with the obstacle K.

The waste liquid tank 50 includes the protrusion 51. The frame 80 includes the boss portion 81 configured to engage with the protrusion 51. Thus, the waste liquid tank 50 is enabled to be easily attached to the frame 80 by engaging the protrusion 51 of the waste liquid tank 50 with the boss portion 81 of the frame 80. Additionally, the waste liquid tank 50 is enabled to be easily removed from the frame 80 by disengaging the protrusion 51 from the boss portion 81 of the frame 80 after the waste liquid tank 50 is rotated with the protrusion 51 engaged with the boss portion 81.

The protrusion 51 has a protruding shape, and the boss portion 81 has a recessed shape. Accordingly, the simple configuration is achieved that enables the waste liquid tank 50 to be easily attached to and removed from the frame 80.

The waste liquid tank 50 includes the projection 52, and the frame 80 includes the plate member 84 having the hole 83. Thus, the waste liquid tank 50 is enabled to be attached to the frame 80 by engaging the projection 52 with the hole 83 of the plate member 84. The waste liquid tank 50 is also enabled to be removed from the frame 80 by disengaging the projection 52 from the hole 83 of the plate member 84. Additionally, the projection 52 is enabled to be easily inserted into the hole 83 and engaged therewith by flexing the plate member 84. Likewise, the projection 52 is enabled to be easily disengaged from the hole 83 by flexing the plate member 84.

The encoder disk 61 is disposed between the waste liquid tank 50 and the cover 93 in the left-right direction D2 in a manner that causes the encoder disk 61 to overlap the rear portion 50B of the waste liquid tank 50 in the left-right direction D2. Thus, removal of the cover 93 and the encoder disk 61 enables the entire left side surface of the waste liquid tank 50 to be exposed to the outside. Accordingly, the waste liquid tank 50 is enabled to be easily attached to and removed from the frame 80. It is noted that the encoder disk 61 is affixed to the disk attachment portion 2A1 with double-sided tape. Therefore, the encoder disk 61 is enabled to be easily attached to and detached from the disk attachment portion 2A1. In another instance, the encoder disk 61 may be fixed to the disk attachment portion 2A1 by other means, such as screws, instead of double-sided tape.

The first portion 74A of the coaxial harness 74 is disposed below the waste liquid tank 50. Thus, even if the first portion 74A is located to the left of the front portion 50A of the waste liquid tank 50, the waste liquid tank 50 is enabled to be attached to and removed from the frame 80 without interfering with the first portion 74A.

The board 71 is disposed to the left of the waste liquid tank 50 and at a position not overlapping the waste liquid tank 50 in the left-right direction D2. Thus, the waste liquid tank 50 is enabled to be attached to and removed from the frame 80 without interfering with the board 71.

The rear portion 50B of the waste liquid tank 50 is longer than the front portion 50A thereof in the left-right direction D2. The rear portion 50B is disposed at a position overlapping the connector 72 in the front-rear direction D1. The front portion 50A is disposed at a position not overlapping the connector 72 in the front-rear direction D1. The wiring arrangement space 100D is disposed to the left of the waste liquid tank 50 and at a position displaced rearward from the connector 72. Accordingly, it is possible to achieve a configuration in which the external connector 110 is mated with the connector 72 without interference between the wiring 111 and the waste liquid tank 50, even while maximizing the volume of the waste liquid tank 50.

The cover 91 and the cover 93 are separable from each other. The cover 91 is configured to cover the waste liquid tank 50 in the front-rear direction D1. Thus, by separating the cover 93 from the cover 91, the waste liquid tank 50 is enabled to be easily attached to and removed from the frame 80.

While aspects of the present disclosure have been described in conjunction with various example structures outlined above and illustrated in the drawings, various alternatives, modifications, variations, improvements, and/or substantial equivalents, whether known or that may be presently unforeseen, may become apparent to those having at least ordinary skill in the art. Accordingly, the example embodiment(s), as set forth above, are intended to be illustrative of the technical concepts according to aspects of the present disclosure, and not limiting the technical concepts. Various changes may be made without departing from the spirit and scope of the technical concepts according to aspects of the present disclosure. Therefore, the disclosure is intended to embrace all known or later developed alternatives, modifications, variations, improvements, and/or substantial equivalents. Some specific examples of potential modifications according to aspects of the present disclosure are provided below.

For instance, the cover 93 may be removable from the frame 80 without removing the cover 91. This configuration allows elimination of time and effort required to remove the cover 91. The cover 93 may be attached to the frame 80 by only one or more screws, or by only one or more engaging claws. The cover 91 and the cover 93 may be configured as an integrated cover.

The waste liquid tank 50 may include a first engaged portion having a recessed shape, instead of the protrusion 51. In this case, the frame 80 may include a first engaging portion having a protruding shape, instead of the boss portion 81. The waste liquid tank 50 may include a second engaged portion having a recessed shape, instead of the projection 52. In this case, the frame 80 may include a second engaging portion having a protruding shape, instead of the hole 83. Even in such cases, substantially the same advantageous effects may still be obtained as those described above.

The printer 100 may not include the encoder 60. The encoder disk 61 and the waste liquid tank 50 may be disposed not to overlap each other in the left-right direction D2. When the first portion 74A of the coaxial harness 74 is disposed to the right of the waste liquid tank 50, the first portion 74A may be positioned above the waste liquid tank 50. The printer 100 may include wiring members other than the coaxial harness 74, or may not include the coaxial harness 74.

When the board 71 is disposed to the right of the waste liquid tank 50, the board 71 may be positioned at a position overlapping the waste liquid tank 50 in the left-right direction D2. The printer 100 may not include the board 71.

The cover 93 may not include the recessed portion 93A. That is, the wiring arrangement space 100D may not be located at a position displaced rearward (i.e., in the removal direction) from the connector 72. The printer 100 may not include the receiver 3.

The type of a “liquid ejection head” (e.g., the head 10) according to aspects of the present disclosure is not limited to a serial type, but may be a line type.

Feasible examples of targets onto which liquid is to be ejected are not limited to sheets, but may include cloth, substrates, boards, and plastic.

The liquid to be ejected from the head 10 may be black ink alone. However, feasible examples of the liquid may include liquids other than ink, such as a treatment liquid that causes components in the ink to aggregate or precipitate.

The printer 100 may not include the image scanner 100B. The liquid ejection device according to aspects of the present disclosure is applicable to a facsimile machine or a copying machine. Furthermore, the present disclosure is applicable to liquid ejection heads used for purposes other than image recording. For instance, the present disclosure may be applied to a liquid ejection head configured to form a conductive pattern on a substrate by ejecting a conductive liquid onto the substrate.

The following provides examples of associations between elements set forth in the aforementioned illustrative embodiment(s) and modification(s), and elements claimed according to aspects of the present disclosure. For instance, the printer 100 may be an example of a “liquid ejection device” according to aspects of the present disclosure. The head 10 may be an example of a “liquid ejection head” according to aspects of the present disclosure. The waste liquid tank 50 may be an example of a “waste liquid tank” according to aspects of the present disclosure. The frame 80 may be an example of a “frame” according to aspects of the present disclosure. The cover 93 may be an example of a “cover” according to aspects of the present disclosure. Each of the up-down directions D3 may be an example of an “up-down direction” according to aspects of the present disclosure. Each of the left-right directions D2 may be an example of a “first direction” according to aspects of the present disclosure. Each of the front-rear directions D1 may be an example of a “second direction” according to aspects of the present disclosure. The protrusion 51 may be an example of a “first engaged portion” according to aspects of the present disclosure. The boss portion 81 may be an example of a “first engaging portion” according to aspects of the present disclosure. The projection 52 may be an example of a “second engaged portion” according to aspects of the present disclosure. The plate member 84 may be an example of a “second engaging portion” according to aspects of the present disclosure. The conveyor 2 may be an example of a “conveyor” according to aspects of the present disclosure. The encoder 60 may be an example of an “encoder” according to aspects of the present disclosure. The encoder disk 61 may be an example of an “encoder disk” according to aspects of the present disclosure. The photosensor 62 may be an example of a “photosensor” according to aspects of the present disclosure. The coaxial harness 74 may be an example of a “wiring member” according to aspects of the present disclosure. The board 71 may be an example of a “board” according to aspects of the present disclosure. The connector 72 may be an example of a “device connector” according to aspects of the present disclosure. The wiring arrangement space 100D may be an example of a “specific region” according to aspects of the present disclosure. The cover 91 may be an example of a “second cover” according to aspects of the present disclosure. The movement mechanism 11 may be an example of a “movement mechanism” according to aspects of the present disclosure. The carriage 12 may be an example of a “carriage” according to aspects of the present disclosure. The receiver 3 may be an example of a “receiver” according to aspects of the present disclosure.

What is claimed is:

1. A liquid ejection device comprising:
a liquid ejection head configured to eject liquid;
a waste liquid tank configured to store waste liquid ejected from the liquid ejection head;
a frame configured to support the liquid ejection head and the waste liquid tank; and
a cover configured to be removably attached to the frame and cover the waste liquid tank in a first direction orthogonal to an up-down direction,
wherein the waste liquid tank has a first length in the first direction and a second length in a second direction orthogonal to the up-down direction and the first direction, the second length being longer than the first length, and
wherein the waste liquid tank is configured to be removably attached to the frame and to be supported by the frame to be rotatable, relative to the frame, about a first end portion of the waste liquid tank in the second direction.

2. The liquid ejection device according to claim 1,
wherein the waste liquid tank includes a first engaged portion disposed at the first end portion, and
wherein the frame includes a first engaging portion configured to engage with the first engaged portion.

3. The liquid ejection device according to claim 2,
wherein the first engaged portion has a protruding shape, and
wherein the first engaging portion has a recessed shape.

4. The liquid ejection device according to claim 2,
wherein the first engaged portion has a recessed shape, and
wherein the first engaging portion has a protruding shape.

5. The liquid ejection device according to claim 2,
wherein the waste liquid tank includes a second engaged portion disposed at a second end portion, the second end portion being opposite to the first end portion in the second direction, and
wherein the frame includes a second engaging portion configured to engage with the second engaged portion.

6. The liquid ejection device according to claim 5,
wherein the second engaged portion includes a projection protruding from the other end of the waste liquid tank in the second direction, and
wherein the second engaging portion includes a plate member having a hole configured to receive the projection.

7. The liquid ejection device according to claim 1, further comprising:
a conveyor configured to convey a recording medium to a position facing the liquid ejection head; and
an encoder configured to detect a conveyance amount of the recording medium conveyed by the conveyor, the encoder comprising:
a photosensor; and
an encoder disk disposed between the waste liquid tank and the cover in the first direction and positioned to overlap the waste liquid tank in the first direction.

8. The liquid ejection device according to claim 1, further comprising a wiring member disposed between the waste liquid tank and the cover in the first direction and positioned below the waste liquid tank.

9. The liquid ejection device according to claim 1, further comprising a board including one or more electronic components mounted thereon, the board being disposed at a position displaced from the waste liquid tank in the second direction and positioned not to overlap the waste liquid tank in the first direction.

10. The liquid ejection device according to claim 9,
wherein the one or more electronic components include a device connector configured to mate with an external connector, the device connector being mounted on the board in such a manner that particular directions are aligned parallel to the second direction, the particular directions including an insertion direction in which the external connector is inserted into the device connector, and a removal direction in which the external connector is removed from the device connector,
wherein the waste liquid tank has a second end portion opposite to the first end portion in the second direction, the second end portion being longer than the first end portion in the first direction, the second end portion being positioned to overlap the device connector in the second direction, while the first end portion is positioned not to overlap the device connector in the second direction, and
wherein the liquid ejection device further comprises a specific region configured to accommodate an external member connected to the external connector mated with the device connector, the specific region being disposed at a position displaced in the removal direction from the device connector and being positioned closer to the cover than the waste liquid tank is in the first direction.

11. The liquid ejection device according to claim 1, further comprising a second cover configured to cover the waste liquid tank in the second direction,
wherein the cover and the second cover are separable from each other.

12. The liquid ejection device according to claim 1, further comprising:
a movement mechanism comprising a carriage and configured to move the carriage, with the liquid ejection head mounted thereon, in the first direction;
a conveyor configured to convey a recording medium in the second direction relative to the liquid ejection head; and
a receiver disposed, in the first direction, closer to the cover than a conveyance region is, the receiver being configured to receive liquid ejected from the liquid ejection head and to guide the received liquid to the waste liquid tank, the conveyance region being a region in which the recording medium is conveyed by the conveyor.

13. The liquid ejection device according to claim 1,
wherein the up-down direction refers to a direction that extends along or intersects with a vertical direction.
